(19) United States
(12) Patent Application Publication
(10) Pub. No.: US 2025/0116423 A1
(43) Pub. Date: Apr. 10, 2025

(54) HEAT-GENERATING DEVICE AND BOILER

(71) Applicant: CLEAN PLANET INC., Tokyo (JP)

(72) Inventors: Yoshito Endo, Tokyo (JP); Yasuhiro Iwamura, Miyagi (JP); Takehiko Ito, Tokyo (JP); Hideki Yoshino, Tokyo (JP)

(73) Assignee: CLEAN PLANET INC., Tokyo (JP)

(21) Appl. No.: 18/687,230

(22) PCT Filed: Aug. 15, 2022
(86) PCT No.: PCT/JP2022/030877

§ 371 Date: Feb. 27, 2024

(30) Foreign Application Priority Data
Aug. 27, 2021 (JP) 2021-139433

(51) Int. Cl. F24H 1/16; F24H 9/00

(52) U.S. Cl. CPC F24H 1/16; F24H 9/0005

(57) ABSTRACT

A heat generating device includes: a heat generating container configured to allow a hydrogen-based gas containing hydrogen to be introduced; a heat generating element provided inside the heat generating container and configured to generate heat by occluding and discharging the hydrogen; a first heat removal path configured to allow a first heat removal fluid heated by the heat generating element to flow therethrough; and a second heat removal path configured to allow a second heat removal fluid to flow therethrough in a direction opposite to a direction in which the first heat removal fluid flows.

### TECHNICAL FIELD

The present invention relates to a heat generating device and a boiler.

### BACKGROUND ART

As a boiler, there is known a boiler configured to efficiently recover heat, for example, by spirally arranging a water pipe so as to surround a heat source (for example, see Patent Literature 1), or by annularly arranging a plurality of water pipes so as to surround a heat source (for example, see Patent Literature 2).

In Patent Literature 1, a heat generating element cell using a hydrogen storage metal or a hydrogen storage alloy is used as a heat source, and the heat generating element cell is heated to generate heat equal to or more than input energy of a heater. Water flow is unidirectional from a lower part to an upper part of the boiler.

In Patent Literature 2, a flame burner is used as a heat source, a water pipe is constituted with an inner water pipe and an outer water pipe, and the inner water pipe and the outer water pipe are connected to each other by an upper header and a lower header. Water or water vapor is circulated upward through the inner water pipe and the outer water pipe from the lower header to the upper header, thereby dispersing heat received by the water pipe from the flame burner.

### CITATION LIST

### Patent Literature

Patent Literature 1: JP6795129B
Patent Literature 2: JPH03-70901A

### SUMMARY OF INVENTION

### Technical Problem

In Patent Literature 1, when a steam flow increase/decrease signal is received from the boiler, it is necessary to vary (load variation) an excess heat amount of the heat generating element cell. When the excess heat amount of the heat generating element cell is attempted to be adjusted according to the load variation, the following problems occur. That is, a temperature of the heat generating element cell decreases on a water pipe inlet side (the lower part of the boiler), and there may be a region where no excess heat is generated. Since the region where no excess heat is generated is generated in the heat generating element cell, the water flowing from the lower part to the upper part of the boiler is not heated enough, and steam may not be generated. In addition, on a water pipe outlet side (the upper part of the boiler), a portion where the temperature of the heat generating element cell is extremely high is generated, and the heat generating element cell may be damaged. Even when the configuration in which the heat received by the water pipe is dispersed as in Patent Literature 2 is applied, the temperature of the heat generating element cell partially decreases or increases.

Therefore, an object of the present invention is to provide a heat generating device and a boiler capable of achieving a uniform temperature of a heat generating element.

### Solution to Problem

A heat generating device according to the present invention includes: a heat generating container configured to allow a hydrogen-based gas containing hydrogen to be introduced; a heat generating element provided inside the heat generating container and configured to generate heat by occluding and discharging the hydrogen; a first heat removal path configured to allow a first heat removal fluid heated by the heat generating element to flow therethrough; and a second heat removal path configured to allow a second heat removal fluid to flow therethrough in a direction opposite to a direction in which the first heat removal fluid flows.

A boiler according to the present invention includes the heat generating device, the first heat removal path is supplied with water as the first heat removal fluid, the water is heated by the heat generating element, and steam or warm water is discharged from the first heat removal path.

### Advantageous Effects of Invention

According to the present invention, the first heat removal fluid and the second heat removal fluid flow in directions opposite to each other, and thus a uniform temperature of the heat generating element can be achieved.

### BRIEF DESCRIPTION OF DRAWINGS

FIG. 1 is a schematic diagram of a boiler according to a first embodiment.

FIG. 2 is a diagram showing a structure of a first heat removal path and a second heat removal path according to the first embodiment.

FIG. 3 is a cross-sectional view showing a structure of a heat generating element.

FIG. 4 is a cross-sectional view showing a structure of a multilayer film.

FIG. 5 is a diagram showing generation of excess heat.

FIG. 6 is a diagram showing a heat generating element having a first layer, a second layer, and a third layer according to a first modification.

FIG. 7 is a diagram showing a heat generating element having a first layer, a second layer, a third layer, and a fourth layer according to a second modification.

FIG. 8 is a schematic diagram of a boiler according to a second embodiment.

FIG. 9 is a diagram showing a structure of a first heat removal path and a second heat removal path according to the second embodiment.

### DESCRIPTION OF EMBODIMENTS

### First Embodiment

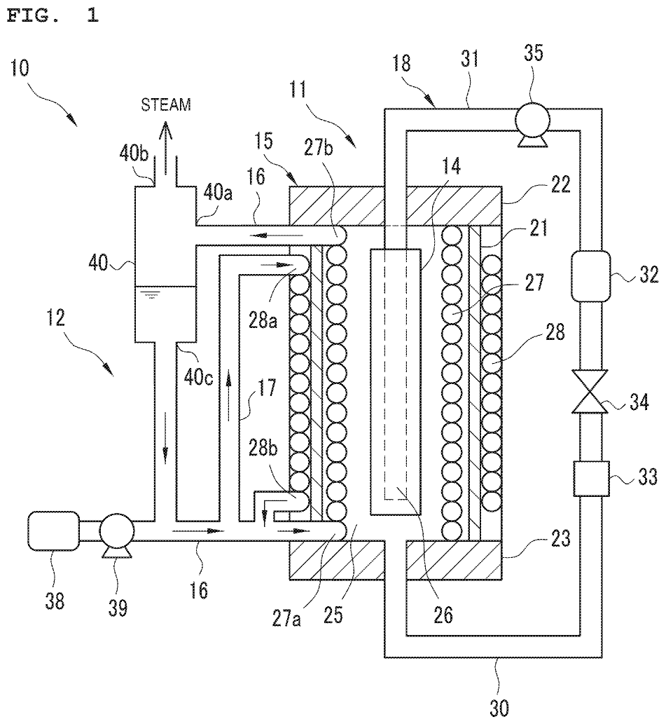

As shown in FIG. 1, a boiler 10 includes a heat generating device 11, a water path 12, and a control unit (not shown). The boiler 10 heats water flowing through the water path 12 by heat generated by the heat generating device 11 to generate steam or warm water. The boiler 10 is used not only for supplying steam but also for supplying warm water like a water heater. That is, the “boiler” in the present application includes a water heater.

The heat generating device 11 includes a heat generating element 14, a heat generating container 15, a first heat removal path 16, a second heat removal path 17, a hydrogen circulation line 18, and a temperature adjustment unit (not shown). The heat generating element 14 is provided inside the heat generating container 15 and generates heat by occluding and discharging hydrogen. The heat generating element 14 is heated by a heater of the temperature adjustment unit to be described later. The heat generating element 14 generates heat (hereinafter, referred to as excess heat) having a temperature equal to or higher than a heating temperature of the heater by occluding and discharging hydrogen. In this example, the heat generating element 14 is formed into a bottomed cylindrical shape. The heat generating element 14 is attached to an upper base 22 of the heat generating container 15 to be described later. A detailed configuration of the heat generating element 14 will be described later with reference to another drawing.

A hydrogen-based gas containing hydrogen is introduced into the heat generating container 15. The heat generating container 15 is a hollow container, and accommodates the heat generating element 14 therein. The heat generating container 15 includes a cylindrical side wall 21, an upper base 22 provided at an upper end of the side wall 21, and a lower base 23 provided at a lower end of the side wall 21. The heat generating container 15 is a sealed container in which an opening at the upper end of the side wall 21 is closed by the upper base 22, and an opening at the lower end of the side wall 21 is closed by the lower base 23. The side wall 21 is formed into a cylindrical shape in the present embodiment, but is not limited thereto, and may be formed into an elliptical cylindrical shape or a rectangular cylindrical shape, for example. In FIG. 1, an axial direction of the heat generating container 15 (the side wall 21) is parallel to the vertical direction of the paper surface.

The heat generating container 15 has therein a first chamber 25 and a second chamber 26 partitioned by the heat generating element 14. The first chamber 25 is defined by a front surface (an outer surface) that is one surface of the heat generating element 14 and an inner surface of the heat generating container 15. The first chamber 25 is connected to an introduction line 30 of the hydrogen circulation line 18 to be described later. The hydrogen-based gas is introduced into the first chamber 25 from the introduction line 30. The second chamber 26 is defined by a back surface (an inner surface) that is the other surface of the heat generating element 14. The second chamber 26 is connected to a lead-out line 31 of the hydrogen circulation line 18 to be described later. The hydrogen-based gas in the second chamber 26 is led out to the lead-out line 31.

The first chamber 25 is pressurized by introducing the hydrogen-based gas. The second chamber 26 is depressurized by leading out the hydrogen-based gas. Accordingly, a hydrogen pressure in the first chamber 25 is higher than a hydrogen pressure in the second chamber 26. The hydrogen pressure in the first chamber 25 is, for example, 100 [kPa]. The hydrogen pressure in the second chamber 26 is, for example, 1×10⁻⁴ [Pa] or less. The second chamber 26 may be in a vacuum state. In this manner, the first chamber 25 and the second chamber 26 have different hydrogen pressures. Therefore, the inside of the heat generating container 15 is in a state in which a pressure difference is generated between two sides of the heat generating element 14.

When the pressure difference is generated between the two sides of the heat generating element 14, a hydrogen molecule contained in the hydrogen-based gas is adsorbed on the front surface (the outer surface) that is one surface of the heat generating element 14 at a high pressure side, and the hydrogen molecule is dissociated into two hydrogen atoms. The hydrogen atoms obtained by dissociation infiltrate into the heat generating element 14. That is, hydrogen is occluded into the heat generating element 14. The hydrogen atoms diffuse into and pass through the heat generating element 14. On the back surface (the inner surface) that is the other surface of the heat generating element 14 at a low pressure side, the hydrogen atoms that pass through the heat generating element 14 are recombined with each other and discharged as a hydrogen molecule. That is, hydrogen is discharged from the heat generating element 14.

In this manner, hydrogen permeates through the heat generating element 14 from the high pressure side to the low pressure side. The phrase “permeate” refers to that hydrogen is occluded on the one surface of the heat generating element and discharged from the other surface of the heat generating element. The heat generating element 14 to be described in detail later generates heat by occluding hydrogen, and generates heat also by discharging hydrogen. Therefore, the heat generating element 14 generates heat by permeation of hydrogen. In the following description, “hydrogen permeates through” the heat generating element may be described as “the hydrogen-based gas permeates through” the heat generating element.

A pressure sensor (not shown) that detects an internal pressure of the first chamber 25 is provided inside the first chamber 25. A pressure sensor (not shown) that detects an internal pressure of the second chamber 26 is provided inside the second chamber 26. The pressure sensors provided in the first chamber 25 and the second chamber 26 are electrically connected to the control unit (not shown), and output signals corresponding to the detected pressures to the control unit.

One end of the first heat removal path 16 is connected to a steam introduction unit 40a of a separator 40 to be described later, and the other end of the first heat removal path 16 is connected to a water discharge unit 40c of the separator 40. A water supply tank 38 is connected to the other end of the first heat removal path 16. A first heat removal fluid flows through the first heat removal path 16. The first heat removal fluid is liquid water or vaporized water (steam).

One end and the other end of the second heat removal path 17 are connected to a high-temperature inlet 27a of a high-temperature heat removal pipe 27 of the first heat removal path 16. A connection portion between the one end of the second heat removal path 17 and the first heat removal path 16 is located upstream of a connection portion between the other end of the second heat removal path 17 and the first heat removal path 16 in the first heat removal path 16. Therefore, a part of the first heat removal fluid (liquid water) flowing through the first heat removal path 16 flows into the one end of the second heat removal path 17. The first heat removal fluid flowing into the second heat removal path 17 is a second heat removal fluid. Therefore, the second heat removal fluid is liquid water. The second heat removal fluid flowing through the second heat removal path 17 flows into the first heat removal path 16 from the other end of the second heat removal path 17 and joins the first heat removal fluid flowing through the first heat removal path 16.

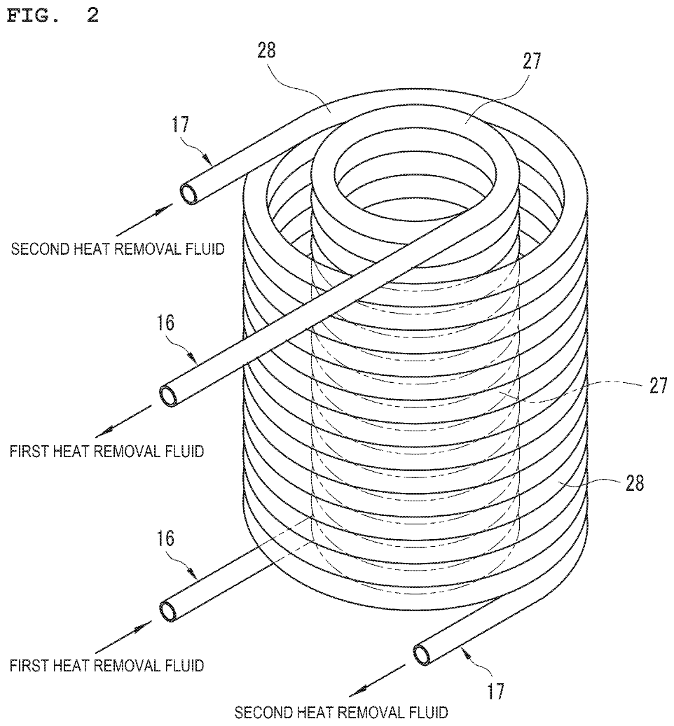

A detailed structure of the first heat removal path 16 and the second heat removal path 17 will be described with reference to FIG. 2.

The first heat removal path 16 includes a high-temperature heat removal pipe 27 provided around the heat generating element 14. The high-temperature heat removal pipe 27 has a high-temperature inlet 27a provided at a lower end of the side wall 21 and a high-temperature outlet 27b provided at an upper end of the side wall 21. The high-temperature heat removal pipe 27 extends spirally along the side wall 21 from the lower end toward the upper end of the side wall 21, and is wound such that there is no gap between the vertically adjacent high-temperature heat removal pipes 27. A cross-sectional shape of the high-temperature heat removal pipe 27 is circular in this example, but is not particularly limited, and may be rectangular or the like.

In the first heat removal path 16, liquid water that has entered the high-temperature heat removal pipe 27 from the high-temperature inlet 27a is heated by the heat generating element 14 in the high-temperature heat removal pipe 27, and exits from the high-temperature outlet 27b as vaporized water (steam). A temperature of the liquid water entering the high-temperature inlet 27a is, for example, 90° C. A temperature of the vaporized water (steam) exiting from the high-temperature outlet 27b is, for example, 100° C. In the present embodiment, a pressure of the high-temperature outlet 27b or a pressure of the separator 40 to be described later is assumed to be 1 atm (0.1 MPa), and the steam at 100° C. is discharged from the first heat removal path 16. However, by applying pressure to the high-temperature outlet 27b or the separator 40 to be described later, liquid water (warm water) having a temperature exceeding 100° C. can be discharged from the first heat removal path 16.

The second heat removal path 17 includes a low-temperature heat removal pipe 28 spirally provided around the first heat removal path 16. The low-temperature heat removal pipe 28 has a low-temperature inlet 28a provided at the upper end of the side wall 21 and a low-temperature outlet 28b provided at the lower end of the side wall 21. The low-temperature heat removal pipe 28 extends spirally along the side wall 21 from the lower end toward the upper end of the side wall 21, and is wound such that there is no gap between the vertically adjacent low-temperature heat removal pipes 28. A cross-sectional shape of the low-temperature heat removal pipe 28 is circular in this example, but is not particularly limited, and may be rectangular or the like.

In the second heat removal path 17, a temperature of liquid water that has entered the low-temperature heat removal pipe 28 from the low-temperature inlet 28a is increased by heat exchange with the first heat removal fluid in the low-temperature heat removal pipe 28, and the liquid water exits from the low-temperature outlet 28b. A temperature of the liquid water entering the low-temperature inlet 28a is, for example, 25° C. A temperature of the liquid water exiting from the low-temperature outlet 28b is, for example, 90° C. That is, in the second heat removal path 17, a temperature of cold water that has entered the low-temperature heat removal pipe 28 is increased by heat exchange with the first heat removal fluid, and the cold water exits from the low-temperature heat removal pipe 28 as warm water. The liquid water (the second heat removal fluid) exiting from the low-temperature outlet 28b joins the liquid water (the first heat removal fluid) flowing through the high-temperature inlet 27a of the high-temperature heat removal pipe 27 in the first heat removal path 16. Accordingly, the temperature of the liquid water (the first heat removal fluid) entering the high-temperature inlet 27a of the high-temperature heat removal pipe 27 is increased.

In the first heat removal path 16, the high-temperature heat removal pipe 27 is provided around the heat generating element 14, and the first heat removal fluid flowing in the high-temperature heat removal pipe 27 is heated by the heat generating element 14. That is, the first heat removal path 16 is configured to allow the first heat removal fluid heated by the heat generating element 14 to flow therethrough.

The high-temperature heat removal pipe 27 of the first heat removal path 16 extends spirally along the side wall 21 from the lower end toward the upper end of the side wall 21. The low-temperature heat removal pipe 28 of the second heat removal path 17 extends spirally along the side wall 21 from the upper end toward the lower end of the side wall 21, contrary to the high-temperature heat removal pipe 27. That is, the second heat removal path 17 is configured to allow the second heat removal fluid to flow therethrough in a direction opposite to a direction in which the first heat removal fluid flows.

The hydrogen circulation line 18 is provided outside the heat generating container 15. One end of the hydrogen circulation line 18 is connected to the upper base 22 of the heat generating container 15, and the other end of the hydrogen circulation line 18 is connected to the lower base 23 of the heat generating container 15 (see FIG. 1). The hydrogen circulation line 18 introduces the hydrogen-based gas containing hydrogen from the outside to the inside of the heat generating container 15 and discharges the hydrogen-based gas from the inside to the outside of the heat generating container 15.

The hydrogen circulation line 18 includes the introduction line 30, the lead-out line 31, a hydrogen tank 32, and a filter 33. Although not shown in FIG. 1, the heat generating device 11 includes a supply line for supplying the hydrogen-based gas to the hydrogen tank 32, and an evacuation line for evacuating the hydrogen-based gas from the hydrogen circulation line 18. For example, the hydrogen-based gas is supplied from the supply line to the hydrogen tank 32 when an operation of the heat generating device 11 is started, and the hydrogen-based gas in the hydrogen circulation line 18 is evacuated to the evacuation line when the operation of the heat generating device 11 is stopped.

The introduction line 30 connects the hydrogen tank 32 and the first chamber 25, and introduces the hydrogen-based gas in the hydrogen tank 32 into the first chamber 25. The introduction line 30 includes a pressure adjustment valve 34. The pressure adjustment valve 34 depressurizes the hydrogen-based gas sent from the hydrogen tank 32 to a predetermined pressure. The pressure adjustment valve 34 is electrically connected to the control unit.

The lead-out line 31 connects the second chamber 26 and the hydrogen tank 32, and leads out the hydrogen-based gas in the second chamber 26 to the hydrogen tank 32. The lead-out line 31 includes a pump 35. The pump 35 leads out the hydrogen-based gas in the second chamber 26 to the lead-out line 31, pressurizes the hydrogen-based gas to a predetermined pressure, and sends the hydrogen-based gas to the hydrogen tank 32. Examples of the pump 35 include a metal bellows pump. The pump 35 is electrically connected to the control unit.

The hydrogen tank 32 stores the hydrogen-based gas. The hydrogen-based gas is a gas containing isotopes of hydrogen. As the hydrogen-based gas, at least one of a deuterium gas and a protium gas is used. The protium gas includes a mixture of naturally occurring protium and deuterium, that is, a mixture in which an abundance ratio of protium is 99.985% and an abundance ratio of deuterium is 0.015%.

The filter 33 removes impurities contained in the hydrogen-based gas. Here, a permeation amount of hydrogen permeating through the heat generating element 14 (hereinafter, referred to as a hydrogen permeation amount) is determined by the temperature of the heat generating element 14, the pressure difference between two sides of the heat generating element 14, and a front surface state of the heat generating element 14. When the hydrogen-based gas contains impurities, the impurities may adhere to the front surface of the heat generating element 14, and may deteriorate the front surface state of the heat generating element 14. When the impurities adhere to the front surface of the heat generating element 14, adsorption and dissociation of the hydrogen molecule on the front surface of the heat generating element 14 are hindered, and the hydrogen permeation amount decreases.

Examples of impurities that hinder the adsorption and dissociation of the hydrogen molecule on the front surface of the heat generating element 14 include water (including steam), hydrocarbons (methane, ethane, methanol, ethanol, and the like), C, S, and Si. It is considered that water is discharged from an inner wall or the like of the heat generating container 15, or is obtained by reducing, by hydrogen, an oxide film contained in a member provided inside the heat generating container 15. It is considered that hydrocarbons, C, S, and Si are discharged from various members provided inside the heat generating container 15. Therefore, the filter 33 at least removes the impurities including water (including steam), hydrocarbons, C, S, and Si. The filter 33 removes the impurities contained in the hydrogen-based gas, so that the hydrogen permeation amount through the heat generating element 14 can be prevented from decreasing.

Although not shown, the temperature adjustment unit adjusts a temperature of the heat generating element 14 and maintains the heat generating element 14 at an appropriate temperature for heat generation. The appropriate temperature for heat generation in the heat generating element 14 is within a range of, for example, 50° C. or higher and 1500° C. or lower. The temperature adjustment unit includes a temperature sensor and a heater. The temperature sensor detects the temperature of the heat generating element 14. The temperature sensor is, for example, a thermocouple, and is provided inside the heat generating container 15. The temperature sensor is electrically connected to the control unit, and outputs a signal corresponding to the detected temperature to the control unit. The heater heats the heat generating element 14. The heater is, for example, an electric heating wire of an electric resistance heat generating type, and is wound around an outer periphery of the heat generating element 14. The heater is electrically connected to a power supply, and generates heat by inputting electric power from the power supply. The heater may be an electric furnace disposed to cover the outer periphery of the heat generating element 14.

The water path 12 includes the first heat removal path 16, the second heat removal path 17, the water supply tank 38, a water pump 39, and the separator 40. The first heat removal path 16 and the second heat removal path 17 constitute a part of the water path 12. The water supply tank 38 supplies the liquid water to the first heat removal path 16. The water pump 39 is provided downstream of the water supply tank 38, and is configured to allow the water in the water path 12 to flow therethrough.

The separator 40 is configured to receive the water (steam) vaporized by heating with the heat generating element 14 in the high-temperature heat removal pipe 27 and to separate the steam from the water (to separate condensate contained in the steam). The steam separated by the separator 40 is supplied to the outside of the boiler 10. The separator 40 includes a steam introduction unit 40a connected to one end of the first heat removal path 16, a steam extraction unit 40b for extracting the steam separated by the separator 40, and a water discharge unit 40c connected to the other end of the first heat removal path 16. The steam introduction unit 40a and the steam extraction unit 40b are provided at an upper part of the separator 40, and the water discharge unit 40c is provided at a lower part of the separator 40. The steam introduction unit 40a introduces the steam from the first heat removal path 16 to the separator 40. The water discharge unit 40c refluxes the water separated by the separator 40 to the other end of the first heat removal path 16.

In the water path 12, the liquid water supplied from the water supply tank 38 flows through a path (between the heat generating container 15 and the water discharge unit 40c) upstream of the high-temperature heat removal pipe 27 of the first heat removal path 16, and the water (steam) heated and vaporized in the high-temperature heat removal pipe 27 flows through a path (between the heat generating container 15 and the steam introduction unit 40a) downstream of the high-temperature heat removal pipe 27 of the first heat removal path 16.

The control unit controls an operation of each unit of the heat generating device 11. The control unit mainly includes, for example, an arithmetic device (a central processing unit), and a storage unit such as a read only memory and a random access memory. The arithmetic device executes various kinds of arithmetic processing using a program, data, and the like stored in the storage unit.

The control unit is electrically connected to the pressure adjustment valve 34, the pump 35, the temperature sensor (not shown), the power supply (not shown), and the like. The control unit controls an output of excess heat generated by the heat generating element 14 by adjusting a pressure of the heat generating container 15, input electric power of the heater (not shown), and the like.

The control unit functions as an output control unit that controls an output of the heater based on the temperature detected by the temperature sensor. The control unit controls the power supply to adjust input electric power to the heater, thereby maintaining the heat generating element 14 at an appropriate temperature for heat generation.

The control unit controls the pressure adjustment valve 34 and the pump 35 to adjust a hydrogen pressure difference generated between the first chamber 25 and the second chamber 26, based on a pressure detected by the pressure sensor (not shown) provided in each of the first chamber 25 and the second chamber 26.

The control unit performs a hydrogen occluding step of occluding hydrogen in the heat generating element 14 and a hydrogen discharging step of discharging hydrogen from the heat generating element 14. In the present embodiment, the control unit simultaneously performs the hydrogen occluding step and the hydrogen discharging step by generating the hydrogen pressure difference between the first chamber 25 and the second chamber 26. The control unit causes a pressure in the first chamber 25 to be higher than a pressure in the second chamber 26 by introducing the hydrogen-based gas from the introduction line 30 to the first chamber 25 and leading out the hydrogen-based gas in the second chamber 26 to the lead-out line 31, and maintains a state in which occluding of hydrogen on the front surface of the heat generating element 14 and discharging of hydrogen on the back surface of the heat generating element 14 are simultaneously performed.

The phrase “simultaneously” in the present disclosure refers to exact simultaneous or refers to a short period of time to an extent that can be regarded as substantially simultaneous. Since hydrogen continuously permeates through the heat generating element 14 by simultaneously performing the hydrogen occluding step and the hydrogen discharging step, the excess heat can be efficiently generated in the heat generating element 14. The control unit may alternately repeat the hydrogen occluding step and the hydrogen discharging step. That is, the control unit may first perform the hydrogen occluding step to occlude hydrogen in the heat generating element 14, and thereafter perform the hydrogen discharging step to discharge hydrogen occluded in the heat generating element 14. In this manner, the excess heat can be generated by the heat generating element 14 by alternately repeating the hydrogen occluding step and the hydrogen discharging step.

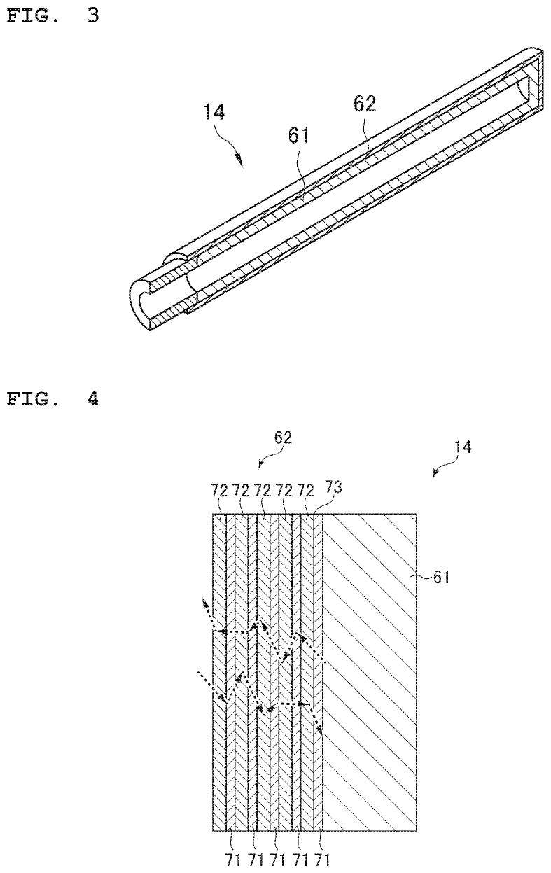

Next, a detailed structure of the heat generating element 14 will be described with reference to FIGS. 3 and 4. As shown in FIG. 3, the heat generating element 14 is formed into a bottomed cylindrical shape with one end opened and the other end closed. The heat generating element 14 includes a support 61 and a multilayer film 62, and the multilayer film 62 is provided on one surface (for example, the front surface) of the support 61. In the heat generating element 14, the multilayer film 62 is formed along an outer peripheral surface and an outer bottom surface of the support 61 formed into a bottomed cylindrical shape with one end opened and the other end closed, and the multilayer film 62 is also formed into a bottomed cylindrical shape with one end opened and the other end closed. In the heat generating element 14, the multilayer film 62 is provided at the first chamber 25 side (a high pressure side), and the support 61 is provided at the second chamber 26 side (a low pressure side) (see FIG. 1). Due to the pressure difference generated between the first chamber 25 and the second chamber 26, hydrogen introduced into the first chamber 25 permeates the inside of the heat generating element 14 sequentially through the multilayer film 62 and the support 61, and moves to the second chamber 26. That is, hydrogen permeates from the outer surface to the inner surface of the heat generating element 14. Accordingly, the heat generating element 14 generates excess heat in a process of hydrogen permeation from the high pressure side to the low pressure side.

The support 61 is made of at least one of a porous body, a hydrogen permeable film, and a proton conductor. In this example, the support 61 is formed into a plate shape having a front surface and a back surface. The porous body has pores having a size through which the hydrogen-based gas can pass. The porous body is made of, for example, a metal, a non-metal, or ceramics. The porous body is preferably made of a material that does not hinder a reaction (hereinafter, referred to as an exothermic reaction) between the hydrogen-based gas and the multilayer film 62. The hydrogen permeable film is made of, for example, a hydrogen storage metal or a hydrogen storage alloy. Examples of the hydrogen storage metal include Ni, Pd, V, Nb, Ta, and Ti. Examples of the hydrogen storage alloy include LaNi₅, CaCu₅, MgZn₂, ZrNi₂, ZrCr₂, TiFe, TiCo, Mg₂Ni, and Mg₂Cu. The hydrogen permeable film is a film having a mesh-like sheet. Examples of the proton conductor include a BaCeO₃-based conductor (for example, Ba(Ce_{0.95}Y_{0.05})O_{3-δ}), a SrCeO₃-based conductor (for example, Sr(Ce_{0.95}Y_{0.05})O_{3-δ}), a CaZrO₃-based conductor (for example, CaZr_{0.95}Y_{0.05}O_{3-α}), a SrZrO₃-based conductor (for example, SrZr_{0.9}Y_{0.1}O_{3-α}), β Al₂O₃, and β Ga₂O₃.

As shown in FIG. 4, the multilayer film 62 is provided on the support 61. The multilayer film 62 has a first layer 71 made of a hydrogen storage metal or a hydrogen storage alloy, and a second layer 72 made of a hydrogen storage metal or a hydrogen storage alloy different from the first layer 71, or ceramics. A heterogeneous material interface 73 to be described later is formed between the support 61 and the first layer 71 and the second layer 72. The multilayer film 62 is formed by alternately stacking the first layer 71 and the second layer 72 in order on one surface (for example, the front surface) of the support 61. The first layer 71 and the second layer 72 each have five layers. The number of layers of each of the first layer 71 and the second layer 72 may be changed as appropriate. The multilayer film 62 may be formed by alternately stacking the second layer 72 and the first layer 71 in order on the front surface of the support 61. The multilayer film 62 preferably has one or more first layers 71 and one or more second layers 72, and one or more heterogeneous material interfaces 73 are preferably formed.

The first layer 71 is made of, for example, any one of Ni, Pd, Cu, Mn, Cr, Fe, Mg, Co, and an alloy thereof. An alloy for forming the first layer 71 is preferably an alloy made of two or more of Ni, Pd, Cu, Mn, Cr, Fe, Mg, and Co. The alloy for forming the first layer 71 may be an alloy obtained by adding an additive element to Ni, Pd, Cu, Mn, Cr, Fe, Mg, and Co.

The second layer 72 is made of, for example, any one of Ni, Pd, Cu, Mn, Cr, Fe, Mg, Co, an alloy thereof, and SiC. An alloy for forming the second layer 72 is preferably an alloy made of two or more of Ni, Pd, Cu, Mn, Cr, Fe, Mg, and Co. The alloy for forming the second layer 72 may be an alloy obtained by adding an additive element to Ni, Pd, Cu, Mn, Cr, Fe, Mg, and Co.

A combination of the first layer 71 and the second layer 72 is preferably Pd—Ni, Ni—Cu, Ni—Cr, Ni—Fe, Ni—Mg, and Ni—Co when types of elements are expressed as “first layer 71-second layer 72 (second layer 72-first layer 71)”. When the second layer 72 is made of ceramics, the “first layer 71-second layer 72” is preferably Ni—SiC.

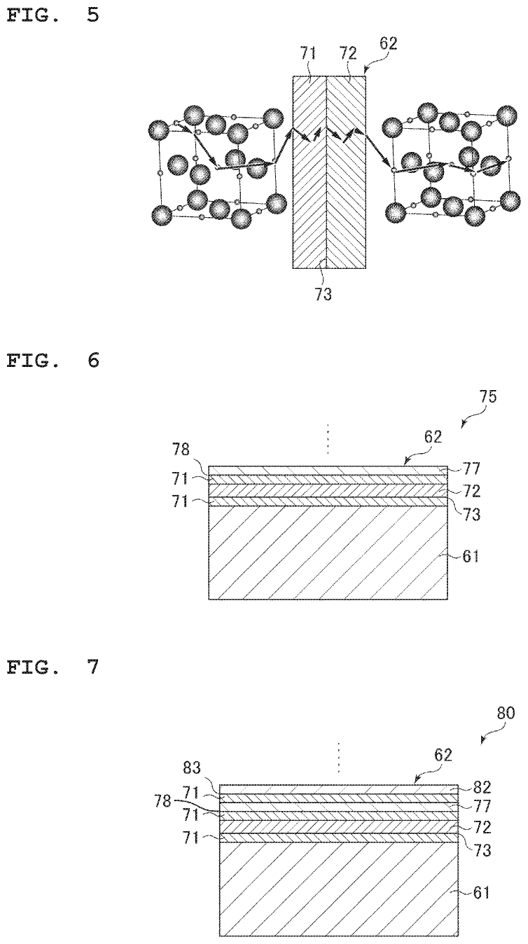

As shown in FIG. 5, hydrogen atoms permeate through the heterogeneous material interface 73. FIG. 5 is a schematic diagram showing a state in which hydrogen atoms in a metal lattice of the first layer 71 permeate through the heterogeneous material interface 73 and move to a metal lattice of the second layer 72 in the first layer 71 and the second layer 72 each made of a hydrogen storage metal having a face-centered cubic structure. It is known that hydrogen is light and hops in a manner of quantum diffusion in hydrogen-occupied sites (octahedral sites or tetrahedral sites) of substance A and substance B. Therefore, hydrogen occluded in the heat generating element 14 hops in the multilayer film 62 in a manner of quantum diffusion. In the heat generating element 14, hydrogen permeates through the first layer 71, the heterogeneous material interface 73, and the second layer 72 in a manner of quantum diffusion.

A thickness of each of the first layer 71 and the second layer 72 is preferably less than 1000 nm. When the thickness of each of the first layer 71 and the second layer 72 is 1000 nm or more, hydrogen is less likely to permeate through the multilayer film 62. When the thickness of each of the first layer 71 and the second layer 72 is less than 1000 nm, a nano-structure that does not exhibit property can be maintained. The thickness of each of the first layer 71 and the second layer 72 is more preferably less than 500 nm. When the thickness of each of the first layer 71 and the second layer 72 is less than 500 nm, a nano-structure that does not exhibit a bulk property at all can be maintained.

Next, an example of a method for manufacturing the heat generating element 14 will be described. First, the support 61 formed into a bottomed cylindrical shape is prepared. Next, the multilayer film 62 is formed on the outer surface of the support 61 using a wet film forming method. Accordingly, the heat generating element 14 having a bottomed cylindrical shape can be manufactured. Examples of the wet film forming method include a spin coating method, a spray coating method, and a dipping method. The multilayer film 62 may be formed by using an atomic layer deposition (ALD) method, or the multilayer film 62 may be formed on the support 61 while rotating the support 61 by using a sputtering device including a rotation mechanism that rotates the support 61. The multilayer film 62 is not limited to being provided on the outer surface of the support 61, and may be provided on an inner surface of the support 61, or on two surfaces of the support 61.

For example, the heat generating element 14 having a bottomed cylindrical shape can be manufactured by forming a sheet-shaped base using a material constituting the support 61, preparing a heat generating sheet by forming the multilayer film 62 on a surface of the sheet-shaped base, and winding the heat generating sheet around the outer surface of the support 61 formed into a bottomed cylindrical shape. In this case, the multilayer film 62 can be formed by using, for example, an evaporation device to make a hydrogen storage metal or a hydrogen storage alloy for forming the first layer 71 or the second layer 72 into a gas phase state, and then alternately forming the first layer 71 and the second layer 72 on the surface of the sheet-shaped base by aggregation or adsorption. The first layer 71 and the second layer 72 are preferably formed continuously in a vacuum state. Accordingly, between the first layer 71 and the second layer 72, no natural oxide film is formed and only the heterogeneous material interface 73 is formed. The evaporation device may be a physical evaporation device in which the hydrogen storage metal or the hydrogen storage alloy is evaporated by a physical method. The physical evaporation device is preferably a sputtering device, a vacuum evaporation device, and a chemical vapor deposition (CVD) device. The hydrogen storage metal or the hydrogen storage alloy may be deposited on the front surface of the support 61 by an electroplating method, and the first layer 71 and the second layer 72 may be alternately formed.

In the heat generating device 11, flow directions of the first heat removal fluid and the second heat removal fluid face each other. Heat from a part (an upper part) of the heat generating element 14 in the vicinity of the high-temperature outlet 27b of the high-temperature heat removal pipe 27 is removed by the second heat removal fluid (cold water) through the first heat removal fluid (steam), so that abnormal temperature rise is prevented. A temperature of a part (a lower part) of the heat generating element 14 in the vicinity of the high-temperature inlet 27a of the high-temperature heat removal pipe 27 is increased by the second heat removal fluid (warm water), so that a temperature decrease is prevented. In this way, the heat generating device 11 can achieve a uniform temperature of the heat generating element 14. In the heat generating device 11, since there is no portion where the temperature of the heat generating element 14 is extremely high, damage to the heat generating element 14 is prevented. Further, the heat generating element 14 can be stably used within an excess heat generation temperature range.

The excess heat of the heat generating element 14 is transferred to the first heat removal fluid via the high-temperature heat removal pipe 27 by convection caused by the hydrogen-based gas in the heat generating container 15 and radiation. The boiler 10 can generate steam (the first heat removal fluid) by heating and vaporizing liquid water (the first heat removal fluid) flowing through the high-temperature heat removal pipe 27 by the excess heat of the heat generating element 14.

The heat generating element 14 can heat the first heat removal fluid by at least one heating method selected from conduction, convection, and radiation. For example, by bringing the heat generating element 14 into contact with the high-temperature heat removal pipe 27, the excess heat of the heat generating element 14 is transferred to the first heat removal fluid by conduction, convection caused by the hydrogen-based gas, and radiation.

Since the heat generating element 14 generates heat using hydrogen, the heat generating element 14 can be said as a clean heat energy source without generating a greenhouse gas such as carbon dioxide. Hydrogen to be used is generated from water and is thus inexpensive. Unlike a nuclear fission reaction, heat generation of the heat generating element 14 is safe since there is no chain reaction.

The present invention is not limited to the first embodiment and can be modified as appropriate without departing from the scope of the present invention. Hereinafter, modifications of the first embodiment will be described. In the drawings and a description of the modifications, the same or equivalent components and members as those in the first embodiment are denoted by the same reference numerals. The repeated description with the first embodiment is omitted as appropriate, and configurations different from those in the first embodiment will be mainly described.

### First Modification

The heat generating device 11 may include a heat generating element 75 shown in FIG. 6 instead of the heat generating element 14. In the heat generating element 75 as shown in FIG. 6, a multilayer film 62 of a stacked body further has a third layer 77 in addition to the first layer 71 and the second layer 72. The third layer 77 is made of a hydrogen storage metal, a hydrogen storage alloy, or ceramics different from the first layer 71 and the second layer 72. A thickness of the third layer 77 is preferably less than 1000 nm. In FIG. 6, the first layer 71, the second layer 72, and the third layer 77 are stacked on the front surface of the support 61 in order of the first layer 71, the second layer 72, the first layer 71, and the third layer 77. The first layer 71, the second layer 72, and the third layer 77 may be stacked on the front surface of the support 61 in order of the first layer 71, the third layer 77, the first layer 71, and the second layer 72. That is, the multilayer film 62 has a stacking structure in which the first layer 71 is provided between the second layer 72 and the third layer 77. The multilayer film 62 preferably has one or more third layers 77. Similarly to the heterogeneous material interface 73, the hydrogen atoms permeate through a heterogeneous material interface 78 formed between the first layer 71 and the third layer 77.

The third layer 77 is made of, for example, any one of Ni, Pd, Cu, Cr, Fe, Mg, Co, an alloy thereof, SiC, CaO, Y₂O₃, TiC, LaB₆, SrO, and BaO. An alloy for forming the third layer 77 is preferably an alloy made of two or more of Ni, Pd, Cu, Cr, Fe, Mg, and Co. The alloy for forming the third layer 77 may be an alloy obtained by adding an additive element to Ni, Pd, Cu, Cr, Fe, Mg, and Co.

In particular, the third layer 77 is preferably made of any one of CaO, Y₂O₃, TiC, LaB₆, SrO, and BaO. In the heat generating element 75 having the third layer 77 made of any one of CaO, Y₂O₃, TiC, LaB₆, SrO, and BaO, an occluding amount of hydrogen is increased, an amount of hydrogen permeating through the heterogeneous material interface 73 and the heterogeneous material interface 78 is increased, and a high output of excess heat can be achieved. The thickness of the third layer 77 made of any one of CaO, Y₂O₃, TiC, LaB₆, SrO, and BaO is preferably 10 nm or less. Accordingly, the hydrogen atoms easily permeate through the multilayer film 62. The third layer 77 made of any one of CaO, Y₂O₃, TiC, LaB₆, SrO, and BaO may not be formed into a complete film shape and may be formed into an island shape. The first layer 71 and the third layer 77 are preferably formed continuously in a vacuum state. Accordingly, between the first layer 71 and the third layer 77, a natural oxide film is not formed and only the heterogeneous material interface 78 is formed.

A combination of the first layer 71, the second layer 72, and the third layer 77 is preferably Pd—CaO—Ni, Pd—Y₂O₃—Ni, Pd—TiC—Ni, Pd—LaB₆—Ni, Ni—CaO—Cu, Ni—Y₂O₃—Cu, Ni—TiC—Cu, Ni—LaB₆—Cu, Ni—Co—Cu, Ni—CaO—Cr, Ni—Y₂O₃—Cr, Ni—TiC—Cr, Ni—LaB₆—Cr, Ni—CaO—Fe, Ni—Y₂O₃—Fe, Ni—TiC—Fe, Ni—LaB₆—Fe, Ni—Cr—Fe, Ni—CaO—Mg, Ni—Y₂O₃—Mg, Ni—TiC—Mg, Ni—LaB₆—Mg, Ni—CaO—Co, Ni—Y₂O₃—Co, Ni—TiC—Co, Ni—LaB₆—Co, Ni—CaO—SiC, Ni—Y₂O₃—SiC, Ni—TiC—SiC, and Ni—LaB₆—SiC when types of elements are expressed as “first layer 71-third layer 77-second layer 72”.

### Second Modification

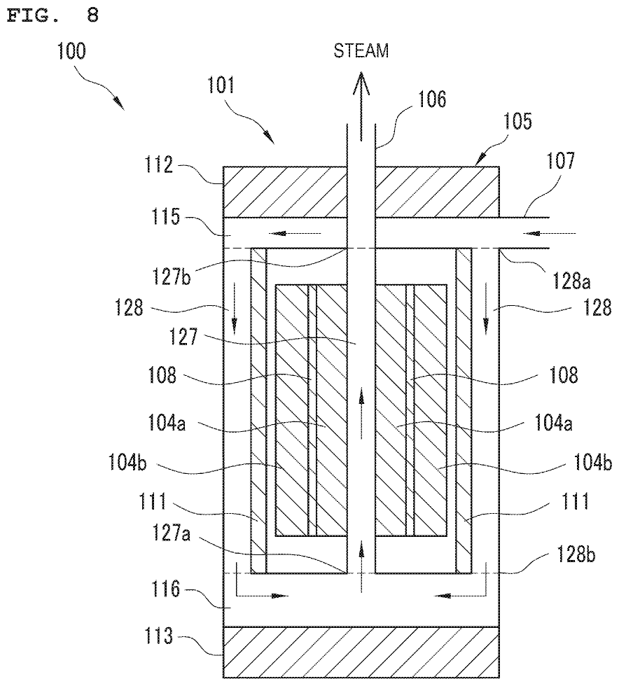

The heat generating device 11 includes a heat generating element 80 shown in FIG. 7 instead of the heat generating element 14. In the heat generating element 80 as shown in FIG. 7, a multilayer film 62 of a stacked body further has a fourth layer 82 in addition to the first layer 71, the second layer 72, and the third layer 77. The fourth layer 82 is made of a hydrogen storage metal, a hydrogen storage alloy, or ceramics different from the first layer 71, the second layer 72, and the third layer 77. A thickness of the fourth layer 82 is preferably less than 1000 nm. In FIG. 7, the first layer 71, the second layer 72, the third layer 77, and the fourth layer 82 are stacked on the front surface of the support 61 in order of the first layer 71, the second layer 72, the first layer 71, the third layer 77, the first layer 71, and the fourth layer 82. The first layer 71, the second layer 72, the third layer 77, and the fourth layer 82 may be stacked on the front surface of the support 61 in order of the first layer 71, the fourth layer 82, the first layer 71, the third layer 77, the first layer 71, and the second layer 72. That is, the multilayer film 62 has a stacking structure in which the second layer 72, the third layer 77, and the fourth layer 82 are stacked in any order and the first layer 71 is provided between the second layer 72 and the third layer 77, between the third layer 77 and the fourth layer 82, and between the second layer 72 and the fourth layer 82. The multilayer film 62 preferably has one or more fourth layers 82. Similarly to the heterogeneous material interface 73 and the heterogeneous material interface 78, the hydrogen atoms permeate through a heterogeneous material interface 83 formed between the first layer 71 and the fourth layer 82.

The fourth layer 82 is made of, for example, any one of Ni, Pd, Cu, Cr, Fe, Mg, Co, an alloy thereof, SiC, CaO, Y₂O₃, TiC, LaB₆, SrO, and BaO. An alloy for forming the fourth layer 82 is preferably an alloy made of two or more of Ni, Pd, Cu, Cr, Fe, Mg, and Co. The alloy for forming the fourth layer 82 may be an alloy obtained by adding an additive element to Ni, Pd, Cu, Cr, Fe, Mg, and Co.

In particular, the fourth layer 82 is preferably made of any one of CaO, Y₂O₃, TiC, LaB₆, SrO, S and BaO. In the heat generating element 80 having the fourth layer 82 made of any one of CaO, Y₂O₃, TiC, LaB₆, SrO, and BaO, an occluding amount of hydrogen is increased, an amount of hydrogen permeating through the heterogeneous material interface 73, the heterogeneous material interface 78, and the heterogeneous material interface 83 is increased, and a high output of excess heat can be achieved. A thickness of the fourth layer 82 made of any one of CaO, Y₂O₃, TiC, LaB₆, SrO, and BaO is preferably 10 nm or less. Accordingly, the hydrogen atoms easily permeate through the multilayer film 62. The fourth layer 82 made of any one of CaO, Y₂O₃, TiC, LaB₆, SrO, and BaO may not be formed into a complete film shape and may be formed into an island shape. The first layer 71 and the fourth layer 82 are preferably formed continuously in a vacuum state. Accordingly, between the first layer 71 and the fourth layer 82, no natural oxide film is formed and only the heterogeneous material interface 83 is formed.

A combination of the first layer 71, the second layer 72, the third layer 77, and the fourth layer 82 is preferably Ni—CaO—Cr—Fe, Ni—Y₂O₃—Cr—Fe, Ni—TiC—Cr—Fe, and Ni—LaB₆—Cr—Fe when types of elements are expressed as “first layer 71-fourth layer 82-third layer 77-second layer 72”.

### Second Embodiment

In the first embodiment, the high-temperature heat removal pipe 27 and the low-temperature heat removal pipe 28 are spirally provided. However, in the second embodiment, a high-temperature heat removal pipe and a low-temperature heat removal pipe are provided in a vertical direction.

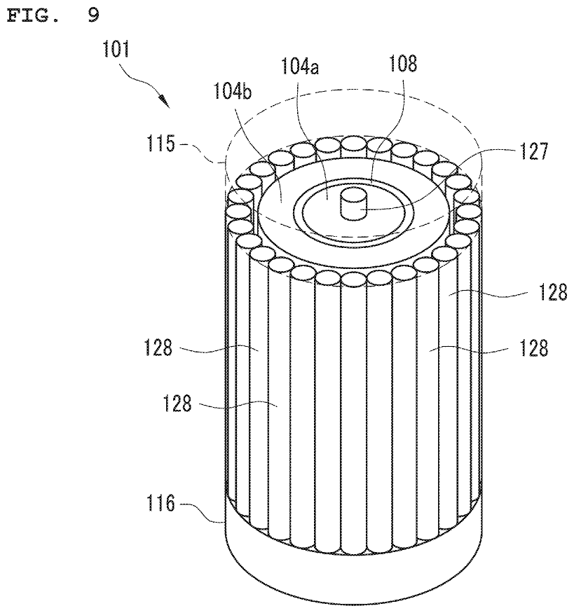

As shown in FIG. 8, a boiler 100 includes a heat generating device 101. Although not shown, the boiler 100 further includes a water path and a control unit as in the first embodiment, and is configured to heat water flowing through the water path by heat generated by the heat generating device 101 to generate steam. In the boiler 100, a configuration of the heat generating device 101 is different from that of the first embodiment, and other configurations are the same as those of the first embodiment.

The heat generating device 101 includes heat generating elements 104a and 104b, a heat generating container 105, a first heat removal path 106, and a second heat removal path 107. A heater 108 is provided between the heat generating element 104a and the heat generating element 104b. Although not shown, the heat generating device 101 further includes a temperature adjustment unit and a hydrogen circulation line similarly to the first embodiment, and is configured such that the temperature of the heat generating elements 104a and 104b is adjusted by the temperature adjustment unit and a hydrogen-based gas is introduced into the heat generating container 105 through the hydrogen circulation line.

As shown in FIG. 9, each of the heat generating elements 104a and 104b is formed into a cylindrical shape. The heat generating element 104a and the heat generating element 104b are concentrically arranged. The heat generating element 104a is provided inside the heat generating element 104b. An axial direction of the heat generating elements 104a and 104b is the vertical direction. In the second embodiment, excess heat can be generated by the heat generating elements 104a and 104b by alternately repeating a hydrogen occluding step and a hydrogen discharging step by the control unit (not shown). That is, the control unit first performs the hydrogen occluding step to occlude hydrogen in the heat generating elements 104a and 104b, and thereafter performs the hydrogen discharging step to discharge hydrogen occluded in the heat generating elements 104a and 104b. In the hydrogen occluding step, a hydrogen-based gas is supplied into the heat generating container 105. In the hydrogen discharging step, the inside of the heat generating container 105 is vacuum evacuated and the heat generating elements 104a and 104b are heated by the heater 108. In this manner, the excess heat can be generated by the heat generating elements 104a and 104b by alternately repeating the hydrogen occluding step and the hydrogen discharging step.

The heat generating container 105 is a hollow container, and accommodates the heat generating elements 104a and 104b therein (see FIG. 8). The heat generating container 105 includes a cylindrical side wall 111, an upper base 112 provided at an upper end of the side wall 111, and a lower base 113 provided at a lower end of the side wall 111. The heat generating container 105 is a sealed container in which an opening at the upper end of the side wall 111 is closed by the upper base 112, and an opening at the lower end of the side wall 111 is closed by the lower base 113. The side wall 111 is formed into a cylindrical shape in the present embodiment, but is not limited thereto, and may be formed into an elliptical cylindrical shape or a rectangular cylindrical shape, for example. The side wall 111 has an upper header 115 at the upper end and a lower header 116 at the lower end. The upper header 115 and the lower header 116 constitute a part of the second heat removal path 107 to be described later. In FIG. 8, an axial direction of the heat generating container 105 (the side wall 111) and the axial direction of the heat generating elements 104a and 104b are parallel to the vertical direction of the paper surface.

The first heat removal path 106 is configured to allow the first heat removal fluid heated by the heat generating elements 104a and 104b to flow therethrough. The first heat removal path 106 includes a high-temperature heat removal pipe 127 provided inside the heat generating element 104a. The high-temperature heat removal pipe 127 extends in the axial direction of the heat generating elements 104a and 104b. In this example, an outer surface of the high-temperature heat removal pipe 127 is in contact with an inner surface of the heat generating element 104a. The high-temperature heat removal pipe 127 has a high-temperature inlet 127a provided at the lower end of the side wall 111 and a high-temperature outlet 127b provided at the upper end of the side wall 111. The high-temperature inlet 127a is connected to the lower header 116. A cross-sectional shape of the high-temperature heat removal pipe 127 is circular in this example, but is not particularly limited, and may be rectangular or the like.

In the first heat removal path 106, liquid water that has entered the high-temperature heat removal pipe 127 from the high-temperature inlet 127a is heated by the heat generating elements 104a and 104b in the high-temperature heat removal pipe 127, and exits from the high-temperature outlet 127b as vaporized water (steam). In the boiler 100 of the present embodiment, a pressure of the high-temperature outlet 127b or a pressure of a separator (not shown) is assumed to be 1 atm (0.1 MPa), and the steam at 100° C., for example, is discharged from the first heat removal path 106. However, by applying pressure to the high-temperature outlet 127b or the separator (not shown), liquid water (warm water) having a temperature exceeding 100° C. can be discharged from the first heat removal path 106.

The second heat removal path 107 is configured to allow the second heat removal fluid to flow therethrough in a direction opposite to a direction in which the first heat removal fluid flows. The second heat removal path 107 includes a plurality of low-temperature heat removal pipes 128 provided along an outer periphery of the heat generating element 104b. The plurality of low-temperature heat removal pipes 128 extend in the axial direction of the heat generating elements 104a and 104b. The plurality of low-temperature heat removal pipes 128 are disposed between the upper header 115 and the lower header 116. Each of the low-temperature heat removal pipes 128 has a low-temperature inlet 128a provided at the upper end of the side wall 111 and a low-temperature outlet 128b provided at the lower end of the side wall 111. The low-temperature inlet 128a is connected to the upper header 115. The low-temperature outlet 128b is connected to the lower header 116. The low-temperature outlet 128b of each of the low-temperature heat removal pipes 128 is connected to the high-temperature inlet 127a of the high-temperature heat removal pipe 127 via the lower header 116. A cross-sectional shape of each of the low-temperature heat removal pipes 128 is circular in this example, but is not particularly limited, and may be rectangular or the like.

In the heat generating device 101, flow directions of the first heat removal fluid and the second heat removal fluid face each other. That is, in the heat generating device 101, along the axial direction of the heat generating elements 104a and 104b, the second heat removal fluid flows from an upper side to a lower side of the heat generating container 105, and the first heat removal fluid flows from the lower side to the upper side of the heat generating container 105. The second heat removal fluid (cold water) that has entered the low-temperature heat removal pipe 128 from the low-temperature inlet 128a is heated by the heat generating elements 104a and 104b in the process of flowing through the low-temperature heat removal pipe 128, and the temperature of the second heat removal fluid increases. The second heat removal fluid (warm water) heated in the low-temperature heat removal pipe 128 exits from the low-temperature outlet 128b and enters the high-temperature inlet 127a of the high-temperature heat removal pipe 127 as the first heat removal fluid (warm water). The first heat removal fluid (warm water) in the high-temperature heat removal pipe 127 is further heated by the heat generating elements 104a and 104b, and exits from the high-temperature outlet 127b as vaporized water (steam). Heat from a part (an upper part) of each of the heat generating elements 104a and 104b in the vicinity of the high-temperature outlet 127b of the high-temperature heat removal pipe 127 is removed by the second heat removal fluid (cold water), so that abnormal temperature rise is prevented. A temperature of a part (a lower part) of each of the heat generating elements 104a and 104b in the vicinity of the high-temperature inlet 127a of the high-temperature heat removal pipe 127 is increased by the second heat removal fluid (warm water), so that a temperature decrease is prevented. In this way, the heat generating device 101 can achieve a uniform temperature of the heat generating elements 104a and 104b as in the first embodiment. In the heat generating device 101, since there is no portion where the temperature of the heat generating elements 104a and 104b is extremely high, damage to the heat generating elements 104a and 104b is prevented. Further, the heat generating elements 104a and 104b can be stably used within an excess heat generation temperature range.

The excess heat of the heat generating elements 104a and 104b is transferred to the first heat removal fluid via the high-temperature heat removal pipe 127 by conduction, convection caused by the hydrogen-based gas, and radiation. The boiler 100 can generate steam (the first heat removal fluid) by heating and vaporizing liquid water (the first heat removal fluid) flowing through the high-temperature heat removal pipe 127 by the excess heat of the heat generating elements 104a and 104b.

The heat generating device 101 includes the heat generating element 104a and the heat generating element 104b, but the number of heat generating elements can be changed as appropriate. A shape of the heat generating element is not limited to the cylindrical shape, and may be a plate shape or the like.

### REFERENCE SIGN LIST

10, 100 boiler
11, 101 heat generating device
14, 75, 80, 104a, 104b heat generating element
15, 105 heat generating container
16, 106 first heat removal path
17, 107 second heat removal path
27, 127 high-temperature heat removal pipe
28, 128 low-temperature heat removal pipe
61 support
62 multilayer film
71 first layer
72 second layer
77 third layer
82 fourth layer
73, 78, 83 heterogeneous material interface

1. A heat generating device comprising:
a heat generating container configured to allow a hydrogen-based gas containing hydrogen to be introduced;
a heat generating element provided inside the heat generating container and configured to generate heat by occluding and discharging the hydrogen;
a first heat removal path configured to allow a first heat removal fluid heated by the heat generating element to flow therethrough; and
a second heat removal path configured to allow a second heat removal fluid to flow therethrough in a direction opposite to a direction in which the first heat removal fluid flows.

2. The heat generating device according to claim 1, wherein
the first heat removal path includes a high-temperature heat removal pipe spirally provided around the heat generating element, and
the second heat removal path includes a low-temperature heat removal pipe spirally provided around the first heat removal path.

3. The heat generating device according to claim 2, wherein
the heat generating container has a cylindrical side wall,
the high-temperature heat removal pipe has a high-temperature inlet provided at a lower end of the side wall and a high-temperature outlet provided at an upper end of the side wall, and
the low-temperature heat removal pipe has a low-temperature inlet provided at the upper end and a low-temperature outlet provided at the lower end.

4. The heat generating device according to claim 1, wherein
the heat generating element has a cylindrical shape,
the first heat removal path includes a high-temperature heat removal pipe provided inside the heat generating element,
the second heat removal path includes a plurality of low-temperature heat removal pipes provided along an outer periphery of the heat generating element, and
the high-temperature heat removal pipe and the plurality of low-temperature heat removal pipes extend in an axial direction of the heat generating element.

5. The heat generating device according to claim 4, wherein
the heat generating container has a cylindrical side wall,
the high-temperature heat removal pipe has a high-temperature inlet provided at a lower end of the side wall and a high-temperature outlet provided at an upper end of the side wall,
the plurality of low-temperature heat removal pipes each has a low-temperature inlet provided at the upper end and a low-temperature outlet provided at the lower end, and
the high-temperature inlet of the high-temperature heat removal pipe and the low-temperature outlet of each of the plurality of low-temperature heat removal pipes are connected.

6. The heat generating device according to claim 1, wherein
the heat generating element heats the first heat removal fluid by at least one heating method selected from conduction, convection, and radiation.

7. A boiler comprising:
the heat generating device according to claim 1, wherein
the first heat removal path is supplied with water as the first heat removal fluid, and
the water is heated by the heat generating element, and steam or warm water is discharged from the first heat removal path.
